(19) United States
(12) Patent Application Publication
(10) Pub. No.: US 2011/0143646 A1
(43) Pub. Date: Jun. 16, 2011

(54) Greenhouse Comprising Ventilation System

(75) Inventor: Anthonie Izak Van Der Kooij, Maasdijk (NL)

(73) Assignees: VAN DER ENDE POMPEN B.V., Maasdijk (NL); ELEKTRAVON-HAKET-TUINBOUWPROJECTPARTNER B.V., Breda (NL)

(21) Appl. No.: 12/995,308

(22) PCT Filed: Jun. 2, 2009
(86) PCT No.: PCT/NL2009/050303

§ 371 Date: Feb. 23, 2011

(30) Foreign Application Priority Data
Jun. 2, 2008 (NL) 1035507

(51) Int. Cl. F24F 7/04; A01G 9/14; A01G 9/24

(52) U.S. Cl. 454/237; 47/17

(57) ABSTRACT

Agricultural and/or horticultural greenhouse for cultivating crops therein, wherein the greenhouse is provided with a ventilation system comprising air displacing means for drawing in air in the upper part of the greenhouse, and wherein the ventilation system is adapted to displace the indrawn air in at least substantially vertical direction in the direction of the lower part of the greenhouse, wherein the ventilation system also comprises at least one substantially tubular air duct for guiding the indrawn air from the upper part of the greenhouse in the direction of the lower part thereof.

The invention relates to an agricultural and/or horticultural greenhouse for cultivating crops therein, wherein the greenhouse is provided with a ventilation system comprising air displacing means for drawing in air in the upper part of the greenhouse, and wherein the ventilation system is adapted to displace the indrawn air in at least substantially vertical direction in the direction of the lower part of the greenhouse. The invention also relates to the ventilation system for use in a greenhouse and a method for controlling the climate in a greenhouse.

Such ventilation systems are generally known.

Particularly in the case of modern, high greenhouses it is a problem that the heat supplied to the greenhouse for the purpose of creating good conditions for the growth of the crops accumulates in the upper part, i.e. close to the roof, of the greenhouse while the lower part, i.e. where the crop is growing, must be additionally heated in order to maintain an optimum temperature.

Particularly under the influence of the lamps generally used in greenhouses to enhance growth, the difference in temperature between the upper and lower part of the greenhouse can rise due to the radiant heat generated by the lamps, since these are generally to be found in the upper part of the greenhouse.

Although attempts have been made to solve this problem, for instance by arranging vertically blowing fans closer the upper part of the greenhouse, these attempts have not produced a satisfactory result in respect of homogeneity of climate, particularly in the height direction of the greenhouse.

The present invention has for its object to provide an efficient, energy-saving and/or inexpensive greenhouse provided with a ventilation system for the purpose of at least partially solving the above stated problems.

The greenhouse of the type stated in the preamble has for this purpose the special feature that the ventilation system also comprises at least one substantially tubular air duct for guiding the indrawn air from the upper part of the greenhouse in the direction of the lower part thereof. The invention is based on the realization that placing vertically blowing air displacing means alone as according to the known solution does not result in a homogeneous temperature distribution in the greenhouse. The crops under the arranged air displacing means are exposed to a relatively strong airflow, while at other locations this influence is minimal. The capacity of the air displacing means according to the known solution is moreover limited in order to prevent possible damage to the crops. A greater capacity will moreover result in even greater differences in temperature.

Such problems are avoided by guiding the air drawn in by the air displacing means from the upper part in the direction of the lower part of the greenhouse by means of an air duct, since the airflow is guided downward while separated from the crops. The capacity of the air displacing means can hereby be increased.

Using the ventilation system according to the invention warm air in the upper part of the greenhouse is suctioned in and displaced through the air duct in the direction of the cooler lower part of the greenhouse without coming into contact with the crop, thereby avoiding local climate change.

It should be noted that although reference is made to a “tubular” air duct, the cross-section of the air duct is not limited to for instance a round form. It can for instance be advantageous in determined cases to embody the air duct with an angular cross-section. In this context a tubular air duct must therefore be understood to mean a hollow long object for the purpose of guiding the air from the upper part of the greenhouse in the direction of the lower part thereof.

In a preferred embodiment of the greenhouse according to the invention the air duct extends at least substantially in vertical direction, whereby a compact assembly is obtained. The inlet side of the air duct preferably extends in the upper part of the greenhouse, whereby the warm air which is available there can be taken up into the air duct and guided in at least substantially vertical direction to the lower part.

Although reference is made here to the “upper part” of the greenhouse, this location is not limited to a location for instance directly below the surface of the roof of the greenhouse. In this context “upper part” is understood to mean the location where the temperature of the air is higher such that it can become advantageous to guide this warm air back in the direction of the crops. It is moreover important not to place the inlet side too closely under the roof, since the suctioning action is then limited.

The inlet side of the air duct preferably extends at a height of about 30 cm below the gutter height, and the inlet side more preferably extends under a gutter, whereby air can be suctioned from the volumes under two ridges.

The inlet side of the air duct preferably extends between the tops of the crop and the roof of the greenhouse, and the inlet side of the air duct more preferably extends close to the tops of the crop in the greenhouse. Warm air is hereby drawn in from above the crops and guided separately in the direction of the crops. An at least substantially homogenous climate is hereby achieved at the position of the crops.

In a further preferred embodiment of the greenhouse according to the invention the air duct is arranged downstream of the air displacing means. The air displacing means here extend in the upper part of the greenhouse and can thus draw in and displace the warm air efficiently in the air duct. The displacing means and the air duct preferably connect at least substantially airtightly for this purpose.

The air displacing means are preferably arranged in the upper part of the greenhouse, wherein the air duct is connected on the inlet side to the air displacing means for vertical guiding of the air drawn in by the air displacing means, and the air duct is more preferably connected in suspended manner to the connecting means. For placing of the ventilation system according to the invention it then suffices to arrange, for instance suspend, the displacing means in the upper part of the greenhouse, wherein the air duct is suspended from the air displacing means and supported thereby. Installations which have to be placed on the ground surface at the position of the crops are hereby not required.

In a further preferred embodiment of the greenhouse according to the invention the outlet side of the air duct extends close to the underside of the crop. It is important according to the invention that at the position of the crops the climate is kept as homogenous as possible and the fewest possible local changes in climate are caused. It is advantageous for this purpose to release the warm air at the underside of the crops, for instance at the roots.

When however the crops are planted in a channel situated a distance from the ground surface of the greenhouse, it is recommended that the outlet side extends under the channel holding the crop. This prevents possible local fluctuations in for instance temperature due to the release of warm air at the crops. The outlet side preferably extends just below the cultivating channel, since the outflow of the air is in this way enhanced.

In a further preferred embodiment of the greenhouse according to the invention the air duct is manufactured from plastic, and the air duct is preferably flexible. In this way an inexpensive and robust air duct is obtained which also causes no damage to the crops. This is highly advantageous particularly when the air duct extends between the crops, for instance suspended from the fan.

In a further preferred embodiment of the greenhouse according to the invention the air displacing means comprise at least one fan. The fan is preferably able to withstand moisture and heat. The air displacing means more preferably have a capacity of about 3000 m³/hour. It will be apparent that this is a significant improvement compared to the known systems.

Although mention is made above of the air duct and the air displacing means which comprise a fan, the skilled person will appreciate that a plurality of air ducts and air displacing means, for instance in the form of fans, can be arranged in a greenhouse at a distance from each other. The mutual distance of the different units, substantially consisting of for instance a fan and a connected air duct, can be determined on the basis of the capacity of the air displacing means such that at least the greater part of the air volume can be drawn in from the upper part of the greenhouse by at least one of the air displacing means.

It must also be appreciated that, although the device provides for an advantageous temperature distribution in the greenhouse, the invention also provides for a good distribution of other climate variables, such as for instance humidity, CO₂ content and oxygen content.

The invention also relates to a ventilation system and an air duct for use in the greenhouse according to the invention.

The invention further relates to a method for controlling the climate in an agricultural and/or horticultural greenhouse, comprising of suctioning in air in the upper part of the greenhouse, guiding the air in at least substantially vertical direction by means of an at least substantially tubular air duct in the direction of the lower part of the greenhouse, and there releasing the indrawn air. The suctioning preferably comprises of drawing in warm air in the upper part of the greenhouse using air displacing means, for instance a fan. And release of the air preferably comprises of releasing air at the position of the underside of the crops, preferably under a channel holding the crops. And the guiding more preferably comprises of guiding the indrawn air separated from the crops so that local variations in for instance temperature are avoided.

The invention will be further elucidated on the basis of a figure of a preferred embodiment of the invention shown in the drawing, in which the ventilation system is shown schematically in a side view.

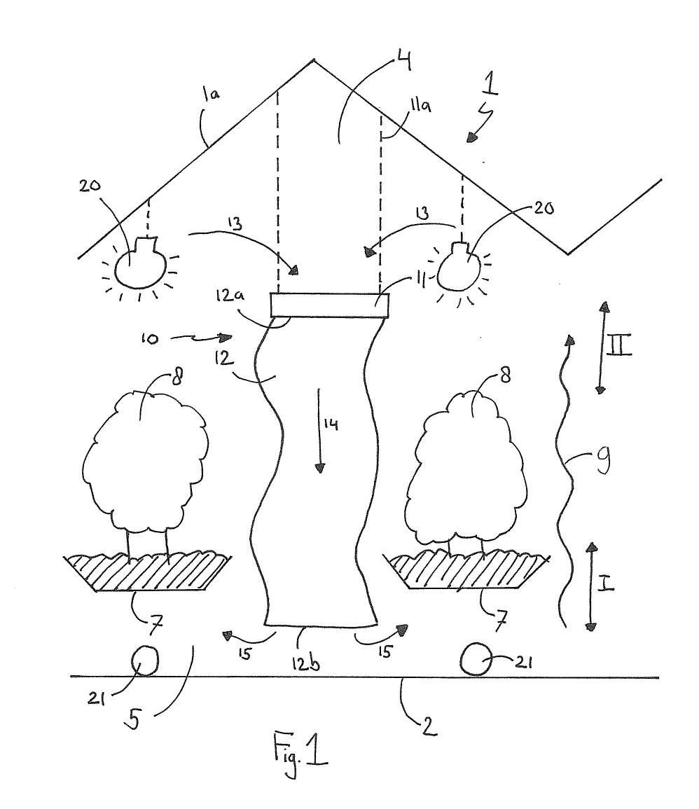

FIG. 1 shows a schematic cross-section of a greenhouse 1 with sloping roofs 1a. Situated in this greenhouse 1 are crops 8 planted in channels 7 which are situated some distance from ground surface 2. Provided in this embodiment for heating greenhouse 1 are heat lamps 20 and heating pipes 21.

It is a problem in greenhouses, and particularly in modern, higher greenhouses, that the heat accumulates in the upper part 4 of greenhouse 1. Apart from the fact that warm air, for instance from pipes 21, tends to rise, as indicated with 9, lamps 20 moreover generate radiant heat as well as light. Since these heating lamps 21 are generally situated at the top of a greenhouse, the upper part 4 of a greenhouse 1 will generally be warmer than a space 5 close to the ground or at the position of crops 8, and costly energy is lost heating the air close to crops 8.

In order to reduce this temperature difference and to provide for an at least substantially homogenous climate over the whole height of greenhouse 1, and in particular at the position of crops 8, a ventilation system 10 is provided. This ventilation system 10 according to the invention consists substantially of air displacing means in the form of a fan 11, to the underside of which is connected a tubular air duct in the form of a plastic hose 12. The diameter of the air duct in this embodiment is 31 cm, and fan 11 has corresponding dimensions. Air duct 12 is connected on the open inlet side 12a to fan 11, and the open outlet side 12b of air duct 12 extends to a position close to ground surface 2 of greenhouse 1.

Fan 11 is suspended a distance II from the tops of crops 8 by means of fastening means, for instance in the form of cables 11a. Air duct 12 is connected with inlet side 12a to the outflow side of fan 11 and is herein suspended from fan 11. Indrawn air, indicated with arrows 13, from the upper part 4 of greenhouse 1 is then guided via the inlet side 12a of hose 12 in vertical direction 14 to the outlet side 12b of air duct 12 situated in the lower part 5 of greenhouse 1. The warm air will then heat crops 8 in the directions 15. It is advantageous here that flow 14 is separated from crops 8.

It is advantageous here for the air outflow 15 to take place at a distance I below crops 8, in this case below channels 7, so that crops 8 are not exposed locally to relatively great differences in climate. If there were for instance no channels 7 for holding crops 8, it would be advantageous to have outflow 15 take place close to the roots of a crop 8.

Air duct 12 is manufactured from a flexible plastic, whereby a light assembly is obtained which can be readily suspended from fan 11. Such a flexible material will moreover cause no damage to crops 8, particularly in cases where air duct 12 is situated in a row of crops instead of between two channels 7 as shown in FIG. 1.

Although only one fan and connected duct is shown in FIG. 1, it will be apparent to the skilled person that a plurality of systems as shown, for instance placed at regular distances from each other, can be arranged in a greenhouse.

Tests with the ventilation system according to the invention have shown that the differences in temperature between the upper part and the lower part of a greenhouse were at least halved. It will be apparent that this will contribute not only toward decreasing energy consumption for the purpose of heating but also toward homogenizing of the climate in the greenhouse.

It is noted that the invention is not limited to the shown embodiments, but also extends to other preferred variants falling within the scope of the appended claims. The skilled person will thus appreciate that, although a greenhouse with sloping roofs is shown here, the invention also relates to greenhouses having for instance flat roofs. The skilled person will also appreciate that the ventilation system, and in particular the fan, can be arranged in different manner in the greenhouse, for instance using chains, on transverse beams of the structure of the greenhouse, or stands intended for this purpose. It can also be possible to use air displacing means other than fans, for instance pumps.

1. An agricultural and/or horticultural greenhouse for cultivating crops therein, wherein the greenhouse is provided with a ventilation system comprising air displacing means for drawing in air in the upper part of the greenhouse, wherein the ventilation system is adapted to displace the indrawn air in at least substantially vertical direction in the direction of the lower part of the greenhouse, and wherein the ventilation system also comprises at least one substantially tubular air duct for guiding the indrawn air from the upper part of the greenhouse in the direction of the lower part thereof.

2. The agricultural and/or horticultural greenhouse as claimed in claim 1, wherein the air duct extends at least substantially vertically.

3. The agricultural and/or horticultural greenhouse as claimed in claim 1, wherein the inlet side of the air duct extends in the upper part of the greenhouse.

4. The agricultural and/or horticultural greenhouse as claimed in claim 1, wherein the inlet side of the air duct extends between the tops of the crop and the roof of the greenhouse.

5. The agricultural and/or horticultural greenhouse as claimed in claim 1, wherein the air duct is arranged downstream of the air displacing means.

6. The agricultural and/or horticultural greenhouse as claimed in claim 5, wherein the air displacing means are arranged in the upper part of the greenhouse, wherein the air duct is connected on the inlet side to the air displacing means for vertical guiding of the air drawn in by the air displacing means.

7. The agricultural and/or horticultural greenhouse as claimed in claim 1, wherein the outlet side of the air duct extends close to the underside of the crop.

8. The agricultural and/or horticultural greenhouse as claimed in claim 1, wherein the outlet side extends under a channel holding the crop.

9. The agricultural and/or horticultural greenhouse as claimed in claim 1, wherein the air duct is manufactured from plastic.

10. The agricultural and/or horticultural greenhouse as claimed in claim 1, wherein the air duct is flexible.

11. The agricultural and/or horticultural greenhouse as claimed in claim 1, wherein the air displacing means comprise at least one fan.

12. The agricultural and/or horticultural greenhouse as claimed in claim 1, wherein the air displacing means have a capacity of about 3000 m³/hour.

13. A ventilation system as claimed in claim 1.

14. An air duct for use in the greenhouse as claimed in claim 1.

15. A method for controlling the climate in an agricultural and/or horticultural greenhouse, comprising the steps of suctioning in air in the upper part of the greenhouse, guiding the air in at least substantially vertical direction by means of an at least substantially tubular air duct in the direction of the lower part of the greenhouse, and there releasing the indrawn air.
